(19) United States
(12) Patent Application Publication
(10) Pub. No.: US 2009/0051131 A1
(43) Pub. Date: Feb. 26, 2009

(54) TOWED EXERCISE APPARATUS

(76) Inventor: Egbert Warrington, Burnaby (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/843,412

(22) Filed: Aug. 22, 2007

(51) Int. Cl. B62B 15/00

(52) U.S. Cl. 280/19

(57) ABSTRACT

An apparatus for exercise and rehabilitation includes a carriage which is towed by an operator walking forward. A hitch assembly is couplable between the carriage and a harness worn by the operator. The hitch assembly includes a tow line extending from the harness and a three-pronged attachment couplable between the tow line and the walls of the carriage. The harness has an inner belt adjacent the waist and at least one outer belt worn over the inner belt, the inner belt being wider than the at least one outer belt. Weights may be placed in the carriage to increase the resistance provided by the carriage.

### TECHNICAL FIELD

This invention relates to a towed apparatus used for personal exercise and physical rehabilitation.

### BACKGROUND

Persons suffering from serious injuries in their back and legs may be placed on a physical therapy exercise program in order to regain their strength and restore functional ability and range of movement in the limbs and other parts of the body. The exercise program may include walking sessions, the duration and intensity of which may increase as the individual heals. However, walking in and of itself may not adequately strengthen the body. As such, walking may be supplemented by exercise devices.

Sleds and carriages exist which may be towed by a person. While these devices are primarily for transport (e.g. equipment on a sled, or a child in a carriage), they also provide exercise benefits for the person towing the device. However, existing devices are intended for use while skiing or jogging, and are not suitable for use indoors or in a confined space. For example, existing devices are not readily able to turn tight corners or reverse direction. Moreover, the harnesses used with these devices provide insufficient support for the body particularly for persons recovering from injuries.

There is a need for a towed exercise apparatus which may be used by a person inside his or her own home or other confined space, and which provides the rehabilitative benefits of walking as well as strengthens and sup-ports the body. There is also a need for a towed exercise apparatus which provides adjustable levels of resistance during walking.

### SUMMARY

One aspect of this invention provides an exercise and strengthening apparatus which an operator may use while walking.

In one embodiment, the apparatus includes a carriage having a planar base, opposing first and second side walls, and opposing front and rear end walls perpendicular to the side walls. The side and end walls extend upwardly from a periphery of the base and define a compartment for placement of a plurality of weights.

The apparatus also includes a harness fastenable around a waist of an operator. The harness may have an inner belt adjacent the waist and at least one outer belt worn over the inner belt.

Further, the apparatus includes a hitch assembly tetherable between the harness and the carriage. The hitch assembly has a tow line extending from the harness, a first prong couplable between the tow line and the first side wall, a second prong couplable between the tow line and the second side wall, and a third prong couplable between the tow line and at least one of the end walls.

Another aspect of the invention provides for a method of exercise, including the steps of fastening a harness around a waist, placing a plurality of weights in a carriage, extending a tow line from the harness, and coupling a first prong between the tow line and a first side wall of the carriage, coupling a second prong between the tow line and a second side wall of the carriage, and coupling a third prong between the tow line and one of the front or rear end walls of the carriage. The operator then tows the carriage by walking in a first direction.

A further aspect of the method includes decoupling the third prong from one of the front or rear end walls and coupling the third prong to the other one of the front or rear end walls before walking in a direction substantially opposite the first direction.

In addition to the exemplary aspects and embodiments described above, further aspects and embodiments will become apparent by reference to the drawings and by study of the following detailed descriptions.

### BRIEF DESCRIPTION OF DRAWINGS

FIG. 1 is a perspective view of an embodiment of a towed apparatus, showing a carriage mounted on castors, and a hitch assembly coupling the carriage to a harness worn by the operator;

FIG. 2 is a rear perspective view of an alternate embodiment of a carriage mounted on rails;

FIG. 3 is a rear perspective view of an alternate embodiment of a carriage mounted on posts and having a lid; and

FIG. 4 is a rear perspective view of a harness, showing a towline extending from the harness.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

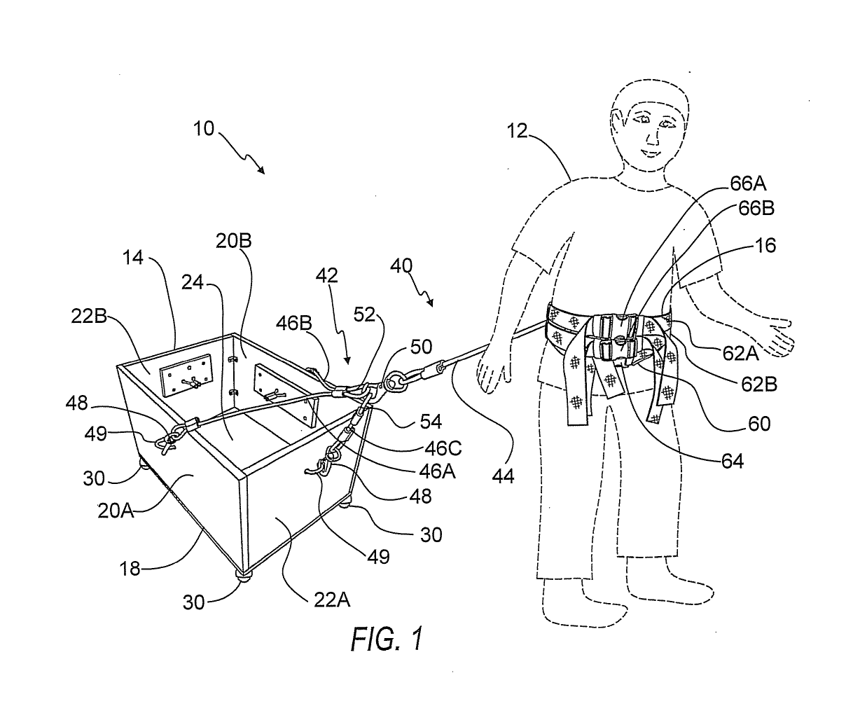

FIG. 1 shows an exercise apparatus 10 for use by an operator 12 while walking. Apparatus 10 includes a carriage 14 couplable to a harness 16 worn by operator 12. Carriage 14 has a planar base 18, opposing first and second side walls 20A, 20B, and opposing front and rear end walls 22A, 22B perpendicular to the side walls. Walls 20A, 20B, 22A and 22B extend upwardly from a periphery of base 18 to define a compartment 24 for placement of a plurality of weights (not shown).

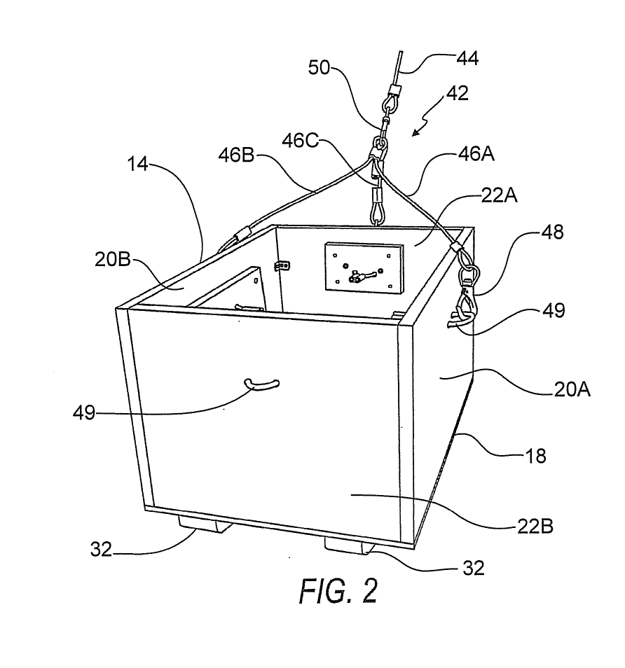

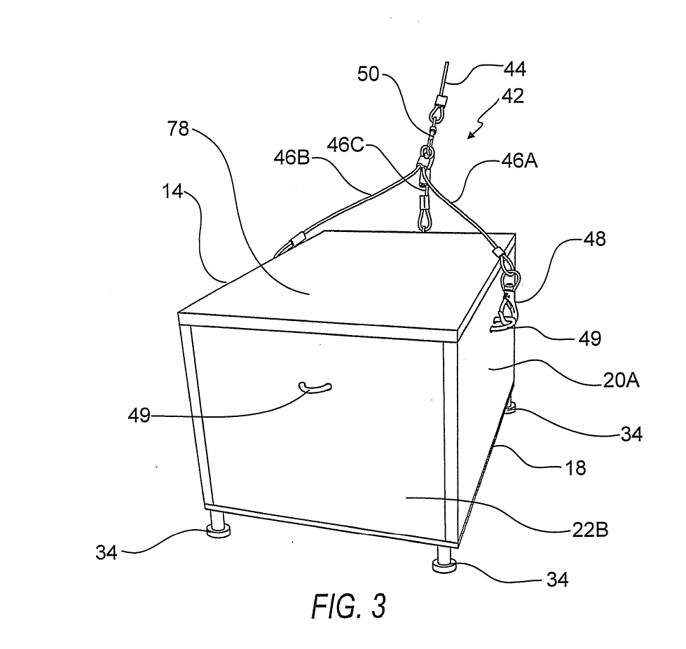

Carriage 14 is towable by operator 12 and may slide directly along the ground or other surface as it is being towed. However, in some embodiments, to reduce wear on carriage 14 and on the ground, and/or to facilitate towing of carriage 14, carriage 14 may be mounted on wheels, castors, rails, cylindrical rollers, posts and the like. For example, carriage 14 may be mounted on four castors 30, one at each corner of carriage 14 (FIG. 1). Castors 30 allow carriage 14 to roll along the ground and facilitates changes in direction of carriage 14. In another embodiment, carriage 14 may be mounted on a pair of generally parallel rails 32 extending from front end wall 22A to rear end wall 22B (FIG. 2). Rails 32 may be covered with padding or cushioned material, such as carpet, to reduce wear on the ground and on carriage 14. In yet another embodiment, carriage 14 may be mounted on four short posts 34, one at each corner of carriage 14 (FIG. 3).

Carriage 14 is couplable to harness 16 by means of a hitch assembly 40. Hitch assembly 40 includes a tow line 44 extending from harness 16, and a three-pronged attachment 42 couplable between tow line 44 and carriage 14. Attachment 42 has prongs 46A, 46B and 46C respectively couplable to first side wall 20A, second side wall 20B, and front end wall 22A of carriage 14 as shown in FIG. 1. Prong 46C may also be couplable to rear end wall 22B so that operator 12 may selectively couple prong 46C to either one of end walls 22A, 22B. Attachment 42 facilitates the turning of carriage 14 as operator 12 changes his or her direction while towing carriage 14. Prongs 46 and tow line 44 may be made of flexible cable or rope, and in some embodiments, they may be adjustable in length.

Each prong 46 may have clasps, carabiners, hooks or other fastening devices for fastening to a wall of carriage 14. In the embodiments shown in FIGS. 1 to 3, each prong 46 is fixed to a clasp 48 which may be removably fastened to a loop 49 installed in each of the walls of carriage 14. Semicircular portions of loops 49 protrude through apertures in the walls to receive clasps 48. These portions may be retracted for storage or shipping. As will be appreciated by a person skilled in the art, other equivalent means may be provided for attaching prongs 46 to the walls of carriage 14. For example, eyebolts or rods may be installed to the walls for receiving a clasp or other fastening device on prongs 46.

Tow line 44 extends between harness 16 and attachment 42. At the end of tow line 44 which is furthest from harness 16, tow line 44 may be fixed to a clasp 50, which is in turn fastenable to loops provided on attachment 42. As shown in FIG. 1, prongs 46A, 46B share a common loop 52 for receiving clasp 50, and prong 46C has a separate loop 54 for receiving clasp 50. Alternate configurations of loops and clasps are possible. For example, all of prongs 46 may have separate loops, or share a common loop, or all of prongs 46 may have clasps for fastening to a loop provided on tow line 44. The use of clasps or other fastening devices between tow line 44 and attachment 42, and between attachment 42 and carriage 14, permits hitch assembly 40 to be completely disassembled into its various components for storage or shipping.

Apparatus 10 may have all prongs 46A, 46B and 46C attached between the walls of carriage 14 and tow line 44 as seen in FIG. 1. Alternately, prongs 46A, 46B may be detached from tow line 44, and also decoupled from carriage 14, so that only prong 46C remains attached between carriage 14 and tow line 44. This results in a single-line tow attachment which may be used by operator 12 as an alternate tow configuration.

Harness 16 has an inner belt 60 fastened around the waist of operator 12 by a clasp 64, and a pair of outer belts 62A, 62B worn over inner belt 60 and fastened around the waist of operator 12 by clasps 66A, 66B. As seen in FIG. 3, outer belts 62A, 62B may be threaded through a plurality of loops 68 affixed to inner belt 60, thereby securing outer belts 62A, 62B to inner belt 60. Inner belt 60 is wider than each of the outer belts 62A, 62B, and braces against the body and offers support during towing of carriage 14. Outer belts 62A, 62B provide additional support. All of the belts have clasps allowing for adjustability (i.e. tightening or loosening of the belt) to accommodate different waist sizes. The belts may be made of flexible, durable textiles.

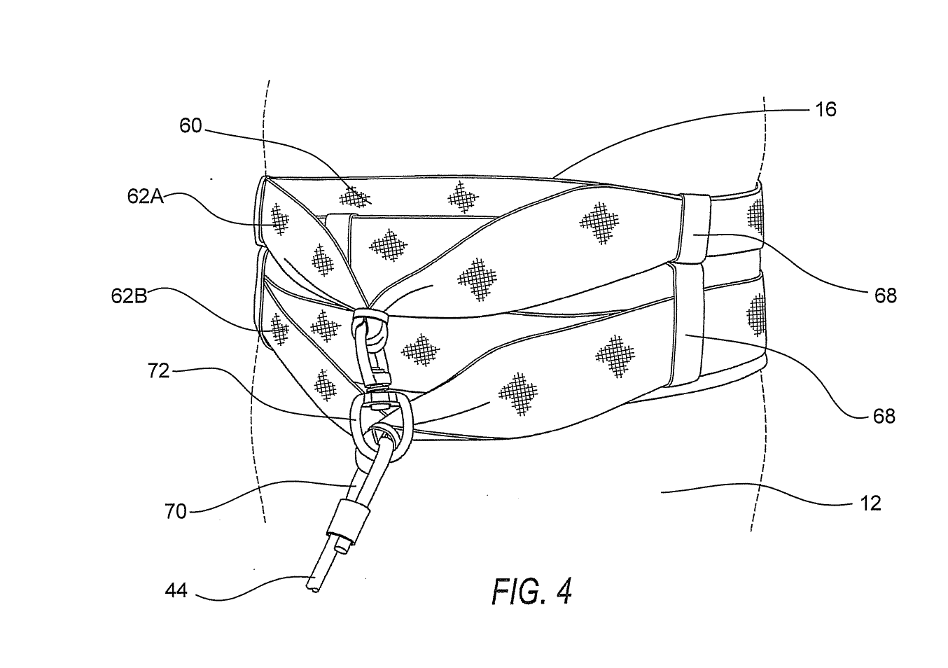

Tow line 44 may be coupled to the rear of harness 16 such that as carriage 14 is towed, the tension in tow line 44 is distributed between outer belts 62A, 62B. One means of accomplishing this is shown in FIG. 4. At the end closest to harness 16, tow line 44 has a loop 70, which is secured to a dual-ring piece 72 and outer belt 62B. Outer belt 62A is secured to dual-ring piece 72.

Carriage 14 may include a removeable lid 78 as shown in FIG. 3. Placement of lid 78 on carriage 14 converts carriage 14 into a table or storage box when it is not being used as an exercise apparatus. Lid 78 may include handles at opposing edges of the lid for more convenient removal and placement of lid 78.

Also, at least portions of the outer walls of carriage 14 may be covered with protective padded material, to reduce wear on furniture and interior building walls as carriage 14 is being towed.

To use apparatus 10, operator 12 fastens harness 16 around his or her waist and adjusts inner belts 60 and outer belts 62A, 62B to achieve a comfortable fit around the waist. Hitch assembly 40 is assembled and coupled between harness 16 and carriage 14. More particularly, tow line 44 is coupled between the rear of harness 16 and attachment 42. Prongs 46A, 46B and 46C of attachment 42 are coupled to first side wall 20A, second side wall 20B, and front end wall 22A of carriage 14, respectively. Assembly and coupling of the various components in hitch assembly 40 may be done before or after harness 16 is fastened around the waist of operator 12.

After operator 12 is coupled to carriage 14, operator 12 walks (or jogs) forward, thereby towing carriage 14 behind him or her. Carriage 14 provides resistance to the movement of operator 12, which assists in strengthening the body of operator 12. The degree of resistance depends on many factors including characteristics of the ground surface, the total weight of carriage 14 including any weights placed in compartment 24, and the type of mounting of carriage 14, if any (e.g. castors 30, rails 32, or posts 34). The resistance of carriage 14 may be adjusted by varying the weights placed in compartment 24. Thus, operator 12 can choose between more strenuous workouts and lighter workouts, or incrementally increase the weight of compartment 24 as operator 12 progresses in a rehabilitation program.

In a confined space, such as inside a home, operator 12 may need to make a 180 degree turn, particularly when he or she encounters a wall or other obstacle. To make a 180 degree (or nearly 180 degree) turn after towing carriage 14 in a given direction, operator 12 can stop, decouple prong 46C from front end wall 22A, and couple prong 46C to rear end wall 22B. Operator 12 then moves in front of rear end wall 22B. As such, operator 12 is ready to resume towing carriage 14 in a direction opposite (or substantially opposite) to the previous direction, without having to make a sharp turn, which may be difficult to do in a confined space.

While a number of exemplary aspects and embodiments have been discussed above, those of skill in the art will recognize certain modifications, permutations, additions and sub-combinations thereof. For example:

carriage 14 may have variations in shape (e.g. carriage 14 may have an oval or hexagonal base 18 with a plurality of side and end walls extending upwardly therefrom).

a different number of outer belts may be used in harness 16 (e.g. one or three outer belts, instead of two).

tow line 44 may be detachable from harness 16.

a seat may be provided in carriage 14 for seating a small child.

It is therefore intended that the following appended claims and claims hereafter introduced are interpreted to include all such modifications, permutations, additions and sub-combinations as are within their true spirit and scope.

What is claimed is:

1. An apparatus for personal exercise, comprising:
a carriage having a planar base, opposing first and second side walls, and opposing front and rear end walls, the side and end walls extending upwardly from a periphery of the base and defining a compartment for placement of a plurality of weights;
a harness fastenable around a waist of an operator; and
a hitch assembly tetherable between the harness and the carriage, the hitch assembly having a tow line extending from the harness, a first prong couplable between the tow line and the first side wall, a second prong couplable between the tow line and the second side wall, and a third prong couplable between the tow line and at least one of the end walls.

2. An apparatus as defined in claim 1, wherein the base of the carriage is mounted on a plurality of castors.

3. An apparatus as defined in claim 1, wherein the base of the carriage is mounted on at least two rails extending generally parallel to the side walls.

4. An apparatus as defined in claim 1, wherein the base of the carriage is mounted on four generally vertical posts having platforms slideable along a floor.

5. An apparatus as defined in claim 1, wherein each of the first, second and third prongs comprises a clasp at an end of the prong proximate the carriage.

6. An apparatus as defined in claim 5, wherein a loop is installed at each of the first side wall, second side wall and at least one of the end walls, to which is couplable the clasp of the first, second and third prongs, respectively.

7. An apparatus as defined in claim 6, wherein a loop is installed at each of the front and rear end walls to which is couplable the clasp of the third prong.

8. An apparatus as defined in claim 7, wherein each of the first, second and third prongs comprises a loop at an end of the prong proximate the tow line, and the tow line is couplable to the loops of the prongs by means of a clasp affixed to the tow line.

9. An apparatus as defined in claim 1, the harness having an inner belt adjacent to the waist and at least one outer belt worn over the inner belt.

10. An apparatus as defined in claim 9, the harness having a pair of outer belts comprising an upper outer belt and an lower outer belt.

11. An apparatus as defined in claim 10, wherein the inner belt is wider than each of the outer belts.

12. An apparatus as defined in claim 10 wherein each of the outer and inner belts is adjustable to accommodate a range of waist sizes.

13. An apparatus as defined in claim 1, comprising a removeable lid for covering the carriage.

14. A method of personal exercise, comprising:
fastening a harness around a waist;
placing a plurality of weights in a carriage to define a weight of the carriage;
extending a tow line from the harness;
coupling a first prong between the tow line and a first side wall of the carriage, coupling a second prong between the tow line and a second side wall of the carriage, and coupling a third prong between the tow line and one of the front or rear end walls of the carriage; and
towing the carriage by walking in a first direction.

15. A method as defined in claim 14, comprising decoupling the third prong from one of the front or rear end walls and coupling the third prong to the other one of the front or rear end walls before walking in a direction substantially opposite the first direction.

16. A method as defined in claim 14, comprising adjusting the weight of the carriage to achieve a desired degree of resistance of the carriage while towing the carriage.

17. A method as defined in claim 14, wherein fastening the harness around the waist comprises fastening an inner belt around the waist and fastening at least one outer belt around the inner belt, the inner belt wider than the at least one outer belt.
